(19) United States
(12) Patent Application Publication
(10) Pub. No.: US 2025/0166211 A1
(43) Pub. Date: May 22, 2025

(54) HYBRID AUTO FOCUS TRACKING METHOD AND HYBRID AUTO FOCUS TRACKING DEVICE

(71) Applicant: Samsung Electronics Co., Ltd., Suwon-si (KR)

(72) Inventors: Jingyu FANG, Suzhou Industrial Park (CN); Yonggang XIE, Suzhou Industrial Park (CN)

(73) Assignee: Samsung Electronics Co., Ltd., Suwon-si (KR)

(21) Appl. No.: 18/537,452

(22) Filed: Dec. 12, 2023

(30) Foreign Application Priority Data
Nov. 17, 2023 (CN) 202311540613.X

(51) Int. Cl. G06T 7/246; G06T 7/70

(52) U.S. Cl. CPC G06T 7/248; G06T 7/70; G06T 2207/20221

(57) ABSTRACT

A hybrid auto focus tracking method and a hybrid auto focus tracking device are provided. The hybrid auto focus tracking method comprises: determining a first lens focusing position based on a phase difference of a phase detection image output by a phase detection image sensor; determining a second lens focusing position based on a zoom ratio of feature points within a region of interest in a scene image output by the phase detection image sensor; determining a final lens focusing position by fusing the first lens focusing position and the second lens focusing position; and performing focus tracking of the phase detection image sensor based on the final lens focusing position.

### CROSS-REFERENCE TO RELATED APPLICATIONS

This application claims priority under 35 U.S.C. § 119 to Chinese Patent Application No. 202311540613.X filed on Nov. 17, 2023 in the State Intellectual Property Office of the P.R.C., the contents of which are incorporated herein by reference in their entirety.

### BACKGROUND

The present inventive concepts relate to image processing, more particularly, to hybrid auto focus tracking methods and hybrid auto focus tracking devices.

Phase detection image sensors are currently applied to imaging systems.

Phase detection image sensors are sensitive to light and fast in a way that measures the distance to the subject and sets the appropriate focus. The phase detection image sensor can calculate the phase difference based on at least two sensors spaced apart from each other and perform Auto Focus by moving the position of the lens based on the phase difference. Auto Focus is a feature that automatically focuses on the subject and can be focused faster and more accurately than Manual Focus.

However, when the phase detection image sensors work in complex environments (for example complex lighting and textures), it is often difficult for the phase detection image sensors to ensure stable and reliable video focus tracking. Therefore, a stable and reliable focus tracking method is needed for the phase detection image sensors to ensure stability and reliability.

### SUMMARY

The present inventive concepts relate to hybrid auto focus tracking methods and hybrid auto focus tracking devices.

In some example embodiments, a hybrid auto focus tracking method is provided, which comprises: determining a first lens focusing position based on a phase difference of a phase detection image output by a phase detection image sensor; determining a second lens focusing position based on a zoom ratio of feature points within a region of interest in a scene image output by the phase detection image sensor; determining a final lens focusing position by fusing the first lens focusing position and the second lens focusing position; and performing focus tracking of the phase detection image sensor based on the final lens focusing position.

In some example embodiments, A hybrid auto focus tracking device is provided, which comprises: a memory, storing executable instructions, and a processor configured to execute the executable instructions to: determine a first lens focusing position based on a phase difference of a phase detection image output by a phase detection image sensor; determine a second lens focusing position based on a zoom ratio of feature points within a region of interest in a scene image output by the phase detection image sensor; determine a final lens focusing position by fusing the first lens focusing position and the second lens focusing position; and perform focus tracking of the phase detection image sensor based on the final lens focusing position.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram showing a hybrid auto focus tracking device according to some example embodiments;

FIG. 2 is a flow diagram showing a hybrid auto focus tracking method according to some example embodiments;

FIG. 3 is a schematic diagram of a method of fusing a first lens focusing position and a second lens focusing position according to some example embodiments;

FIG. 4 is a schematic diagram showing a function corresponding to a weight factor of signal-to-noise ratio (SNR) according to some example embodiments;

FIG. 5 is a flow diagram showing a hybrid auto focus tracking method according to some example embodiments;

FIG. 6 is a block diagram showing an electronic device according to some example embodiments; and

FIG. 7 is a schematic diagram showing a pixel structure of a phase detection image sensor according to some example embodiments.

Throughout the drawings and some example embodiments, unless otherwise described or provided, the same drawing reference signs will be understood to represent the same elements, features and structures. The drawings may not be proportional, and relative dimensions, proportions and descriptions of elements in the drawings may be exaggerated for clarity, illustration and convenience.

### DETAILED DESCRIPTION

The following some example embodiments are provided to assist readers to obtain a comprehensive understanding of the methods, devices and/or systems described herein. However, after understanding the inventive concepts of the present application, various changes, modifications and equivalents of the methods, devices and/or systems described herein will be clear. For example, the order of operations described herein is only an example and is not limited to those described herein, but may be changed as will be clear after understanding the inventive concepts of the present application, except for operations that must be performed in a specific order. In addition, in order to increase clarity and conciseness, the description of features known after understanding the inventive concepts of the present application may be omitted.

As used herein, the singular form “a” and “an” are intended to include the plural forms as well, unless the context clearly indicates otherwise. Although the terms first, second, and the like may be used herein to describe various elements, components, steps, and/or operations, these terms are only used to distinguish one element, component, step or operation from another element, component, step, or operation.

It will be understood that an operation that is described herein to be performed “by” performing another operation or sub-operation may be performed “based on” the other operation or sub-operation, such that the operation may be performed based on a set of operations and/or sub-operations that may include the other operation or sub-operation alone or in combination with other operations or sub-operations.

The features described herein may be implemented in different forms and should not be construed as limited to the examples described herein. Instead, the examples described herein have been provided to show only some of many feasible ways to implement the methods, devices and/or systems described herein that will be clear after understanding the inventive concepts of the present application.

In some example embodiments, a lens focusing position may have a same or similar meaning as a lens focusing position. The lens focusing position may indicate the distance from a focal plane of the lens to an imaging plane.

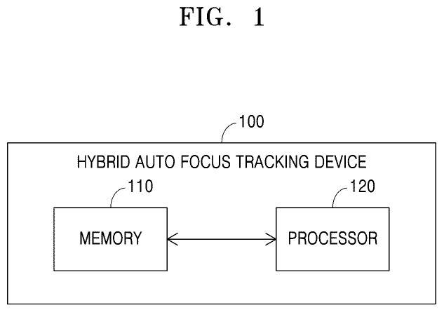

FIG. 1 is a block diagram showing a hybrid auto focus tracking device according to some example embodiments.

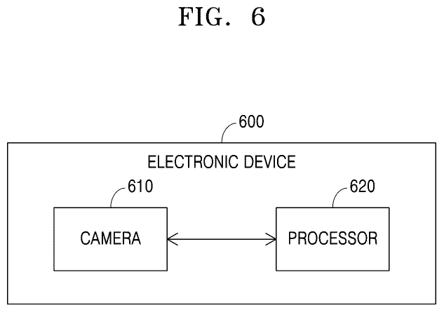

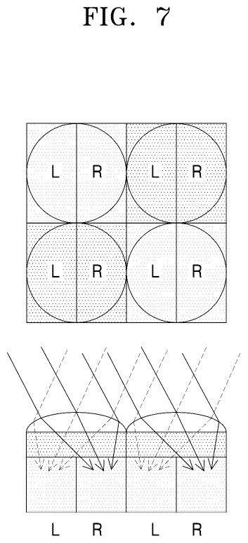

Referring to FIG. 1, a hybrid auto focus tracking device 100 may comprise a memory 110 and a processor 120. In some example embodiments, the hybrid auto focus tracking device 100 may further include a phase detection image sensor (e.g., an internal phase detection image sensor), such as camera 610 that is shown in FIG. 6. However, it will be understood that example embodiments are not limited thereto, and in some example embodiments the phase detection image sensor (e.g., included in camera 610) may be external to the hybrid auto focus tracking device 100 and thus may not be included as part of the hybrid auto focus tracking device 100 (e.g., the hybrid auto focus tracking device 100 may not include any internal phase detection image sensors). For example, the phase detection image sensor may be a camera 610 shown in FIG. 6, and the hybrid auto focus tracking device 100 may be connected with the camera 610 and may include a processor that is the processor 620 of FIG. 6. The camera 610 may be external to the hybrid auto focus tracking device 100 in a same electronic device 600 or in separate electronic devices that are communicatively coupled to each other. The phase detection image sensor may have various forms of pixel structures. In some example embodiments, the phase detection image sensor may have a pixel structure as shown in FIG. 7. The pixel structure in FIG. 7 may also be referred to as an all dual pixel structure. Referring to FIG. 7, the left phase detection pixel L may collect light from the right side of a microlens through the microlens, and the right phase detection pixel R may collect light from the left side of the microlens through the microlens. Although FIG. 7 shows an example of a pixel structure of a phase detection image sensor according to some example embodiments, example embodiments are not limited thereto, and the phase detection image sensor may also have any other pixel structure including a phase detection pixel.

Although not illustrated in FIG. 1, the hybrid auto focus tracking device 100 may be connected with an external memory and/or may communicate with an external device (also referred to herein as a remote device). The hybrid auto focus tracking device 100 illustrated in FIG. 1 may comprise components associated with some example embodiments. Thus, it will be apparent for those skilled in the art that the hybrid auto focus tracking device 100 may also comprise other general components not illustrated in FIG. 1.

In some example embodiments, the hybrid auto focus tracking device 100 may be implemented using various types of devices such as a personal computer (PC), a server device, a mobile device, an embedded device, and the like. For example, the hybrid auto focus tracking device 100 may be and/or may be included in smart phones, tablet devices, augmented reality (AR) devices, Internet of things (IoT) devices, autonomous vehicles, robot devices or medical devices that may capture and/or process images, but example embodiments are not limited thereto.

In some example embodiments, the memory 110 stores various data processed in the hybrid auto focus tracking device 100. For example, the memory 110 may store data that has been processed or will be processed in the hybrid auto focus tracking device 100. In some example embodiments, the memory may store instructions executable in the processor 120 (e.g., may store executable instructions). In addition, the memory 110 may store applications or drivers that will be driven by the hybrid auto focus tracking device 100.

For example, the memory 110 may comprise a random access memory (RAM) (such as a dynamic random access memory (DRAM) or a static random access memory (SRAM)), a read only memory (RAM), an electrically erasable programmable read only memory (EEPROM), a CD-ROM, a Blu-ray disc, an optical disc storage device, a hard disc drive (HDD), a solid state drive (SSD), or a flash memory.

The processor 120 may control an overall function of the hybrid auto focus tracking device 100. For example, the processor 120 may generally control the hybrid auto focus tracking device 100 by performing a program stored in the memory 110 (e.g., executing a program and/or executable instructions stored in the memory 110). The processor 120 may be implemented as a central processing unit (CPU) a graphics processor (CPU) or an application processor (AP) included in the hybrid auto focus tracking device 100 for processing data, but example embodiments are not limited thereto. For example, the memory 110 may store executable instructions, and the processor 120 may be configured to execute the executable instructions that are stored in the memory 110 to implement and/or perform any of the functions of the hybrid auto focus tracking device 100, any of the methods according to any of the example embodiments (e.g., any of the hybrid auto focus tracking method as described herein), any combination thereof, or the like.

In some example embodiments, the processor 120 may read data (for example, a phase detection image output by the phase detection image sensor) from the memory 110 or write the data to the memory 110 and perform the focus tracking of the phase detection image sensor by processing read/written data. For example, when instructions (also referred to herein as executable instructions) are executed in the processor 120, the processor 120 may be configured to determine a first lens focusing position based on a phase difference of a scene image output by a phase detection image sensor; determine a second lens focusing position based on a zoom ratio of feature points within a region of interest (ROI) in the phase detection image; determine the final lens focusing position by fusing the first lens focusing position and the second lens focusing position; and perform focus tracking of the phase detection image sensor based on the final lens focusing position.

For example, the hybrid auto focus tracking device 100 may fuse the focusing position based on the phase detection image output by the phase detection sensor and the focusing position based on the ROI feature points to determine the final lens focusing position, and perform the focus tracking based on the final lens focusing position.

Therefore, the hybrid auto focus tracking device 100 according to some example embodiments may balance the advantages of the focusing position based on the phase detection image output by the phase detection sensor and the focusing position based on the ROI feature points, thereby improving the stability and reliability of the video focus tracking process.

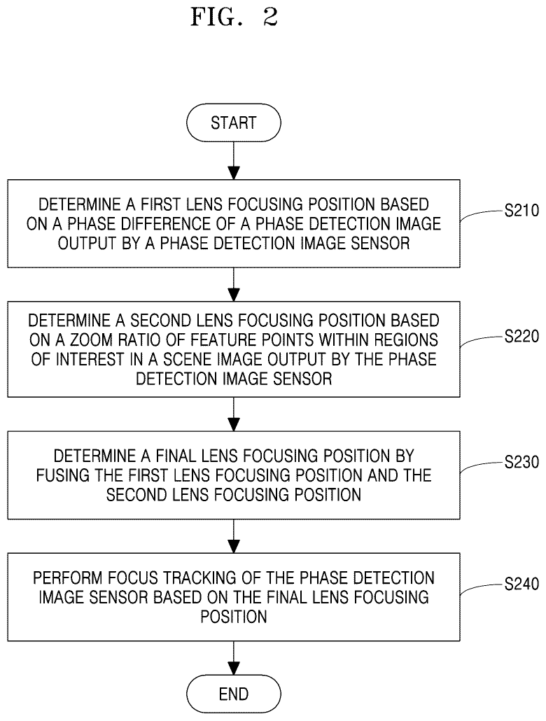

Hereinafter, an example of the hybrid auto focus tracking method performed by the processor 120 according to some example embodiments will be described with reference to FIGS. 2 to 7.

FIG. 2 is a flowchart showing the hybrid auto focus tracking method according to some example embodiments. It should be understood that the method shown in FIG. 2 may be implemented by any device including, for example, the hybrid auto focus tracking device 100 shown in FIG. 1, based on a processor 120 executing executable instructions stored in memory 110, according to some example embodiments.

Referring to FIG. 2, in operation S210, the processor may determine a first lens focusing position based on a phase difference of a phase detection image output by the phase detection image sensor.

In some example embodiments, the phase detection image sensor may include phase detection (PD) pixels, and the phase detection image may be obtained through the phase detection pixels of the phase detection image sensor (for example, based on electrical signals generated by the phase detection pixels of the phase detection image sensor). After obtaining the phase detection image, the phase difference of the phase detection image may be determined in various ways.

For example, the generation of the phase detection image may be performed on a processor inside the phase detection image sensor or on a processor outside the phase detection image sensor (such as processor 120 in FIG. 1). For example, a frame of data generated by capturing a scene using the phase detection image sensor may be converted into a phase detection image and a scene image to be described below according to some example embodiments.

In some example embodiments, the first lens focusing position may be determined based on the phase difference by a predetermined equation indicating the relationship between the phase difference and the first lens focusing position.

In some example embodiments, an addition result may be obtained by adding a product of a predetermined first lens calibration coefficient and a lens current position to a product of a predetermined second lens calibration coefficient and the phase difference. Then, the result value obtained by dividing the addition result by a sum of the first lens calibration coefficient and the phase difference is determined as the first lens focusing position. For example, a predetermined equation may correspond to a fractional model as shown in equation (1) below:

$${P}_{pd} = \frac{{K}_{1} {P}_{cur} + {K}_{2} D}{{K}_{1} + D} \qquad equation ( 1 )$$

In equation (1), P_{pd} represents the first lens focusing position, P_{cur} represents the lens current focusing position, read from a drive module, D is the phase difference, K₁ and K₂ represent the module calibration coefficients of the lens (i.e., the first lens calibration coefficient and the second lens calibration coefficient). In addition, the first lens focusing position may be written onto the driving module of the lens, and the lens current focusing position may be read out from the driving module of the lens.

In some example embodiments, a table lookup method may be used to determine the first lens focusing position based on the phase difference. For example, a lookup table that records the phase difference and the first lens focusing position may be predetermined, and the first lens focusing position may be determined based on the lookup table and the obtained phase difference.

In operation S220, the processor may determine a second lens focusing position based on a zoom ratio of feature points within regions of interest in a scene image output by the phase detection image sensor.

In some example embodiments, the phase detection image sensor may include pixels configured to sense the light intensity of incident light (also referred to as pixels for sensing light intensity herein). The scene image may be obtained by detecting the pixels of the light intensity sensed by the phase detection image sensor (for example, based on the electrical signal generated by the pixels of the light intensity sensed by the phase detection image sensor). In some example embodiments, the pixels of the sensing light intensity of the phase detection image sensor may be RGB pixels or YUV pixels. However, the one or more pixels used for sensing light intensity according to some example embodiments are not limited thereto, and may also be other pixels used for sensing light intensity.

In some example embodiments, Region of Interest (ROI) may be used for object tracking. For example, the area of interest may be delineated according to the focused object. The area of interest may be regions of various shapes (such as, for example, a rectangular framed area). In addition, in some example embodiments, the ROI moving synchronously with the focused object is implemented by tracking the focused object. Target tracking algorithms based on the regions of interest include but are not limited to Bayesian estimation, online learning, etc.

In some example embodiments, the second lens focusing position may be determined based on the zoom ratio of the feature points in the region of interest by a predetermined equation indicating the relationship between the zoom ratio of the feature points in the region of interest and the second lens focusing position.

In some example embodiments, a first result may be obtained by dividing the zoom ratio by the lens current position. Then, a second result may be obtained by dividing a difference between 1 and the zoom ratio by the focal length of the lens. A reciprocal of a sum of the first result and the second result may be determined as the second lens focusing position. For example, the predetermined equation may correspond to equation (2) as follows:

$$\frac{1}{{P}_{fp}} = \frac{K}{{P}_{cur}} + \frac{1 - K}{f} \qquad equation ( 2 )$$

In equation (2), K is the zoom ratio, f is the focal length of the lens, P_{fp} is the second lens focusing position, and P_{cur} is the lens current focusing position.

In addition, the feature points within the ROI may be extracted using various feature extraction algorithms (for example, as an example only, the Scale Invariant Feature Transform (SIFT algorithm).

In some example embodiments, the zoom ratio is obtained based on position fitting of feature points in the region of interest and the camera projection model. For example, as shown in equation (3) below, the camera projection model may be used to fit and obtain the zoom ratio:

$$[ \begin{matrix}K & 0 & bx \\ 0 & K & by\end{matrix} ] = {( {P}^{′ T} {P}^{′} )}^{- 1} {P}^{′ T} \qquad equation ( 3 )$$

In equation (3), K is the zoom ratio, P is a matrix composed of coordinates of the feature points of the current frame, P′ is the homogeneous matrix composed of coordinates of the feature points of the previous frame, and bx and by represent the translation coordinates of the focused object.

The specific matrices of P and P′ are represented by equation (4) as follows:

$$P = [ \begin{matrix}{x}_{1} & … & {x}_{n} \\ {y}_{1} & … & {y}_{n}\end{matrix} ] , \qquad equation ( 4 )$$

$${P}^{′} = [ \begin{matrix}{x}_{1}^{′} & … & {x}_{n}^{′} \\ {y}_{1}^{′} & … & {y}_{n}^{′} \\ 1 & … & 1\end{matrix} ]$$

In equation (4), xᵢ and yᵢ are the abscissa and ordinate of the feature point i of the current frame, xᵢ′ and yᵢ′ are the abscissa and ordinate of the feature point i of the previous frame, and n is the number of feature points.

In operation S230, the processor may determine a final lens focusing position by fusing the first lens focusing position and the second lens focusing position.

Generally, in some example embodiments, focusing based on phase detection sensor and focusing based on regions of interest both have blind spots in focusing. The output performance of the phase detection sensor (such as, for example, the output performance of the phase detection image) may be, for example, greatly affected by lighting and texture. For lower lighting, lower texture details, or certain fixed high-frequency textures, the output accuracy of the phase detection sensor (such as the output accuracy of the phase detection image) will decrease. The size of the region of interest itself has lower accuracy and stability, and there is a relatively great error when encountering deformable objects.

In some example embodiments, for example as mentioned above, the first lens focusing position may be determined based on the phase difference of the phase detection image output by the phase detection image sensor, and the second lens focusing position may be determined based on the zoom ratio of the feature points within the region of interest in the scene image output by the phase detection image sensor.

Therefore, according to some example embodiments, the final lens focusing position may be determined by fusing the first lens focusing position and the second lens focusing position, thereby improving the stability and reliability of the lens focusing position compared to either individual focusing position (such as, for example, either the focusing position based on the phase detection sensor or the focusing position based on the region of interest).

In operation S240, the processor may perform focus tracking of the phase detection image sensor based on the final lens focusing position.

For example, the processor may perform the focus tracking of the phase detection image sensor by adjusting the lens focusing position to the final lens focusing position. Since the processor uses lens focusing positions with improved stability and reliability, the stability and reliability of the video focusing process are improved.

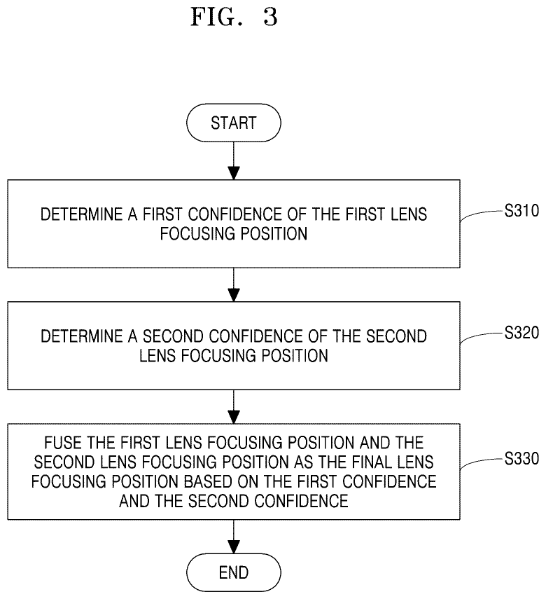

FIG. 3 is a schematic diagram showing a method of fusing the first lens focusing position and the second lens focusing position according to some example embodiments.

Referring to FIG. 3, in operation S310, the processor may determine a first confidence of the first lens focusing position, wherein the first confidence indicates a reliability that the first lens focusing position is able to be the final lens focusing position.

In some example embodiments, the reliability that the first lens focusing position is able to be the final lens focusing position may indicate the reliability of phase detection focusing. For example, the greater the first confidence, the higher the reliability.

In some example embodiments, the first confidence is determined based on one or more of a weight factor of signal-to-noise ratio, a texture weight factor, and a correlation weight factor during phase difference calculation. In some example embodiments, the higher the signal-to-noise ratio of the phase detection image, the greater the weight factor of the signal-to-noise ratio, and the greater the first confidence. In some example embodiments, the more complex the texture of the phase detection image, the greater the texture weight factor, and the greater the first confidence. In some example embodiments, the smaller the correlation error of the phase detection image, the greater the correlation weight factor, and the greater the first confidence.

In some example embodiments, as shown in equation (5) below, the first confidence may be calculated by multiplying multiple weighting factors:

$${C}_{pd} = {f}_{SNR} \cdot {f}_{t} \cdot {f}_{pd} \qquad equation ( 5 )$$

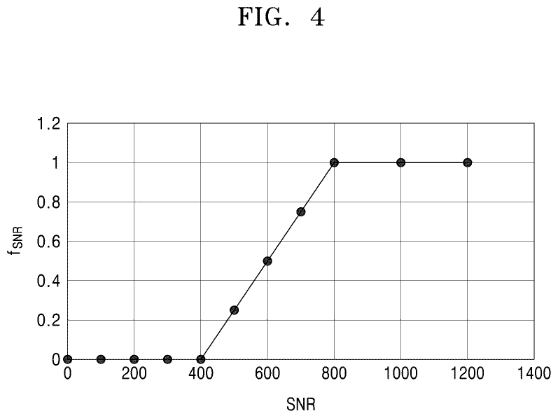

In equation (3), C_{pd} is the first confidence (e.g., the confidence of the PD focusing position), f_{SNR} is the weight factor of the signal-to-noise ratio (SNR), fₜ is the texture weight factor, and f_{pd} is the correlation weight factor during phase difference calculation. These three factors are only examples, and multiple weighting factors may use other factors, and each factor function is also an adjustable function. For example, the f_{SNR} function may use a piecewise linear function as shown in FIG. 4.

The above example embodiments are only illustrative, and the first confidence may also be obtained through various calculations of weight factors. For example, various weight factors are not limited to the weight factors for signal-to-noise ratio, the texture weight factors, and the correlation weight factors during the phase difference calculation described above, but may include any weight factor associated with the reliability of the phase detection focusing.

In operation S320, the processor may determine a second confidence of the second lens focusing position, wherein the second confidence indicates a reliability that the second lens focusing position is able to be the final lens focusing position.

In some example embodiments, the reliability that the second lens focusing position is able to be the final lens focusing position may represent the reliability of feature point focusing. For example, the higher the second confidence, the higher the level of reliability.

In some example embodiments, the smaller the fitting error when calculating the zoom ratio, the greater the second confidence. For example, the second confidence may be a negative correlation function of the fitting error when calculating the zoom ratio of the camera projection model.

In operation S330, the processor may fuse the first lens focusing position and the second lens focusing position as the final lens focusing position based on the first confidence and the second confidence.

According to some example embodiments, for example as mentioned above, the first confidence indicates the reliability that the first lens focusing position is able to be the final lens focusing position, and the second confidence indicates the second lens focusing position is able to be the final lens focusing position may represent the reliability of feature point focusing. Therefore, the hybrid auto focus tracking method according to some example embodiments takes into account the reliability that the first lens focusing position is able to be the final lens focusing position and the reliability that the second lens focusing position is able to be the final lens focusing position to fuse the first lens focusing position and the second lens focusing position, and thus, a more accurate final lens focusing position may be obtained.

For example, when the first confidence is fixed, the higher the second confidence, the closer the final lens focusing position is to the second lens focusing position. In addition, when the second confidence is fixed, the greater the first confidence, the closer the final lens focusing position is to the first lens focusing position.

In some example embodiments, an addition result may be obtained by adding a product of the first lens focusing position and the first confidence to a product of the second lens focusing position and the second confidence. Then, a resulting value obtained by dividing the addition result by a sum of the first confidence and the second confidence may be calculated as the final lens focusing position.

In some example embodiments, by considering more the lens focusing position corresponding to a relatively high confidence among the first confidence and the second confidences, the calculated final lens focusing position value may be more reliable.

In some example embodiments, in response to the sum of the first confidence and the second confidence being greater than a predetermined threshold, the addition result may be obtained by adding the product of the first lens focusing position and the first confidence to the product of the second lens focusing position and the second confidence, and the resulting value obtained by dividing the addition result by the sum of the first confidence and the second confidence may be calculated as the final lens focusing position. In addition, in response to the sum of the first confidence and the second confidence being less than or equal to the predetermined threshold, the final lens focusing position of the previous frame is set as the final lens focusing position of the current frame.

For example, the first lens focusing position and the second lens focusing position may be fused as the final lens focusing position by equation (6):

$${P}_{com} = \{ \begin{matrix}\frac{{C}_{pd} {P}_{pd} + {C}_{fp} {P}_{fp}}{{C}_{pd} + {C}_{fp}} , & if {C}_{pd} + {C}_{fp} > th \\ {P}_{default} , & else\end{matrix} \qquad equation ( 6 )$$

In equation (6), P_{com} is the final lens focusing position, P_{pd} is the first lens focusing position, P_{fp} is the second lens focusing position, P_{default} is the default position (for example, the lens focusing position of the previous frame), th is a confidence threshold as an adjustable parameter, C_{pd} is the first confidence, C_{fp} is the second confidence.

The hybrid auto focus tracking method according to some example embodiments may fuse the first lens focusing position and the second lens focusing position into the final lens focusing position when the sum of the first confidence and the second confidence is greater than the threshold value, and determine the final lens focusing position as the lens focusing position of the previous frame when the sum of the first confidence and the second confidence is less than or equal to the threshold value. Therefore, the hybrid auto focus tracking method according to some example embodiments provides a more accurate final lens focusing position for better video focusing.

In addition, in some example embodiments, the lens focusing position of the current frame may be obtained by filtering and smoothing the final lens focusing position of the current frame and the final lens focusing positions of one or more previous frames. Then, based on the lens focusing position, the focus tracking of the phase detection image sensor is performed.

According to the hybrid auto focus tracking method of some example embodiments, the lens focusing position may be smoothed and filtered between different frames, and thus, the obtained lens focusing position is more reliable.

In some example embodiments, a FIR filter or an IIR filter may be used to perform the smooth filtering process. For example, the following equation 7 may be used to perform smoothing filtering:

$${P}_{0}^{f} = {\sum }_{0}^{- n} {b}_{i} {P}_{i}^{com} + {\sum }_{- 1}^{- m} {a}_{j} {P}_{j}^{f} \qquad equation 7$$

In Equation 7, bᵢ and aⱼ are adjustable filter coefficients, Pⱼ^{f} is a filtered focusing position relative to the jth frame of the current frame, Pᵢ^{com} is the fused focusing position of the i-th frame, P₀^{f} is the filtered focusing position of the current frame, and n and m represent the first n frame and the first m frame of the current frame participating in the filtering, respectively. For example, 0 represents the current frame, −1 represents a previous frame, and −2 represents a frame previous the previous frame.

Although it is shown in the above example that FIR filtering or IIR filtering may be used to perform smoothing filtering processing, example embodiments are not limited thereto, and the algorithm used to perform smoothing filtering processing may also be any other smoothing algorithm or filtering algorithm.

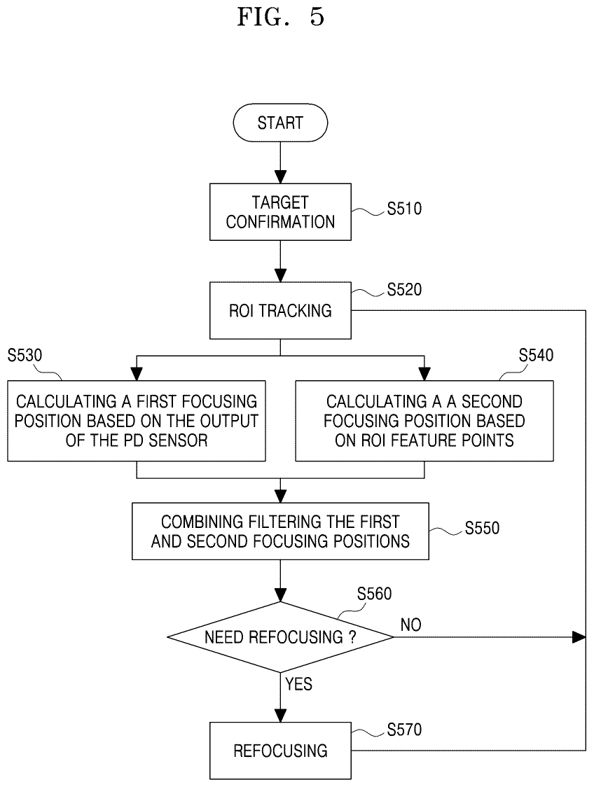

FIG. 5 is a flow diagram showing the hybrid auto focus tracking method according to some example embodiments.

Referring to FIG. 5, in operation S510, target confirmation may be performed. In some example embodiments, target confirmation may include confirmation of the focused object (for example, a pre-shot object such as a face, a car, etc.) in the image frame before focusing, which may be automatically confirmed by the imaging system, or may be manually specified and confirmed, and initial focus is performed after confirmation. Target confirmation may be achieved by any existing means.

In operation S520, ROI tracking of the focused object may be performed. For example, based on the focused object confirmed in operation S510, the ROI (for example, an area framed in a rectangle) may be delineated and the ROI region moving synchronously with the focused object is implemented by tracking the focused object. Target tracking algorithms to achieve ROI tracking of the focused object include but are not limited to Bayesian estimation, online learning, etc., and may achieve ROI tracking of focused objects in any other existing way.

In operation S530, a first focusing position based on the output of the PD sensor may be calculated. For example, the output of the PD sensor includes the phase detector image of the PD sensor or the phase difference of the phase detector image, and may be obtained in any existing way. In some example embodiments, the calculation method for the first focusing position may be the same as the calculation method for the first lens focusing position. The calculation method for the first lens focusing position has been described above in conjunction with one or more example embodiments, and in order to avoid redundancy, the calculation method for the first focusing position will not be repeated here.

In operation S540, a second focusing position based on ROI feature points may be calculated. For example, the zoom ratio of ROI feature points between different frames (e.g., different scene images) may be calculated. In some example embodiments, the calculation method for the second focusing position may be the same as the calculation method for the second lens focusing position. The calculation method for the second lens focusing position has been described above in conjunction with one or more example embodiments, and in order to avoid redundancy, the calculation method for the second focusing position will not be repeated here.

In operation S550, the first and second focusing positions may be combined and filtered. In some example embodiments, the combination may correspond to the fusion described above according to some example embodiments, and the filtering may correspond to the filtering and/or smoothing described above according to some example embodiments. In operation S550, the resulting value may be used as the final lens focusing position.

In operation S560, whether refocusing is needed may be determined based on the final lens focusing position. For example, whether the refocusing is needed may be determined based on the difference between the final lens focusing position and the lens current focusing position.

In some example embodiments, when it is determined that the refocusing is not needed, the method may return to operation S520. For example, when the difference between the final lens focusing position and the lens current focusing position is less than or equal to a predetermined threshold, it may be determined that there is no need to refocus and may be returned to operation S520.

In some example embodiments, when it is determined that the refocusing is needed, the refocusing may be performed in operation S570. For example, when the difference between the final lens focusing position and the lens current focusing position is greater than a predetermined threshold, it may be determined that the refocusing is needed and the refocusing may be performed.

FIG. 6 is a block diagram showing an electronic device according to some example embodiments.

Referring FIG. 6, an electronic device 600 may include a camera 610 and a processor 620. For example, the electronic device 600 may be applied to or installed in robot devices (such as, for example, an unmanned aircraft and an advanced driver assistance system (ADAS)), smart TVs, smart phones, medical devices, mobile devices, image display devices, measurement devices, IoT devices, and any other various types of electronic devices, but example embodiments are not limited thereto.

In some example embodiments, the camera 610 may include a phase detection image sensor and may be configured to capture (e.g., obtain) images (e.g., scene images). In some example embodiments, the processor 620 may perform operations similar to those performed by the processor 120 described with reference to FIG. 1. For example, the processor 620 may determine a first lens focusing position based on a phase difference of a phase detection image output by a phase detection image sensor; determine a second lens focusing position based on a zoom ratio of feature points within a region of interest (ROI) in a scene image output by the phase detection image sensor; determine the final lens focusing position by fusing the first lens focusing position and the second lens focusing position; and perform focus tracking of the phase detection image sensor based on the final lens focusing position. For example, in some example embodiments, the electronic device 600 may include the hybrid auto focus tracking device 100 shown in FIG. 1, where processor 620 may be the processor 120 of the hybrid auto focus tracking device 100. Camera 610 may be external to the hybrid auto focus tracking device 100 within the electronic device 600, such that, for example, the camera 610 and the hybrid auto focus tracking device 100 are separate devices included within the electronic device 600 and communicatively coupled therebetween within the electronic device 600, where the hybrid auto focus tracking device 100 may not include any internal phase detection image sensors. In some example embodiments, camera 610 may be internal to the hybrid auto focus tracking device 100 within the electronic device 600.

The hybrid auto focus tracking method according to some example embodiments may balance the advantages of the focusing position based on the phase detection image output by the phase detection sensor and the focusing position based on the ROI feature points, thereby improving the stability and reliability of the video focus tracking process.

According to some example embodiments, the final lens focusing position may be determined by fusing the first lens focusing position and the second lens focusing position, thereby improving the stability and reliability of the lens focusing position compared to either individual focusing position (such as either the focusing position based on the phase detection sensor or the focusing position based on the region of interest).

The hybrid auto focus tracking method according to some example embodiments may fuse the first lens focusing position and the second lens focusing position into the final lens focusing position when the sum of the first confidence and the second confidence is greater than the threshold value, and determine the final lens focusing position as the lens focusing position of the previous frame when the sum of the first confidence and the second confidence is less than or equal to the threshold value. Therefore, the hybrid auto focus tracking method according to some example embodiments may provide a more accurate final lens focusing position for better video focusing.

According to the hybrid auto focus tracking method of some example embodiments, the lens focusing position may be smoothed and filtered between different frames, and thus, the obtained lens focusing position is more reliable.

One or more of the methods described above according to some example embodiments, may be written as a program executable on a computer (e.g., as executable instructions) and may be implemented on a universal digital computer operating the program by using a non-transient (e.g., non-transitory) computer-readable recording medium. Various devices may be used to record the structure of the data used in the above methods on a computer-readable recording medium. The computer-readable recording medium may include a storage medium (e.g., memory), such as a magnetic storage medium (e.g., a ROM, a RAM, a Universal Serial Bus (USB), a floppy disk, a hard disk, etc.), an optical recording medium (e.g., an optical disc (CD)-ROM, a digital universal optical disc (DVD), etc.), and the like, but example embodiments are not limited thereto.

Some example embodiments may be described and illustrated in accordance with a frame and/or block that performs one or more of the described functions. These blocks, which may be referred to herein as units or modules, etc., are physically implemented by analog and/or digital circuits (such as logic gates, integrated circuits, microprocessors, microcontrollers, memory circuits, passive electronic components, active electronic components, optical components, hardwired circuits, etc.) and may optionally be driven by firmware and/or software. For example, the circuit may be implemented in one or more semiconductor chips or on a substrate support, such as a printed circuit board and the like. The circuits that make up the blocks may be implemented by dedicated hardware, or by a processor (e.g., one or more programmed microprocessors and associated circuits), or by a combination of dedicated hardware that performs some functions of the blocks and a processor that performs other functions of the blocks. Without departing from the scope of the present inventive concepts, each block of some example embodiments may be physically divided into two or more interacting and discrete blocks. Similarly, the frames of some example embodiments may be physically combined into more complex frames without departing from the scope of the present inventive concepts. One aspect of some example embodiments may be implemented by instructions stored in a non-transient storage medium (e.g., a solid-state drive (SSD) memory) and executed by a processor (e.g., a central processing unit (CPU).

As described herein, any devices, systems, blocks modules, units, controllers, circuits, and/or portions thereof according to any of the example embodiments (including, without limitation, hybrid auto focus tracking device 100, memory 110, processor 120, electronic device 600, camera 610, processor 620, or the like) may include, may be included in, and/or may be implemented by one or more instances of processing circuitry or a processor such as hardware including logic circuits; a hardware/software combination such as a processor executing software; or a combination thereof. For example, the processing circuitry or processor more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry or processor may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, blocks modules, units, controllers, circuits, and/or portions thereof according to any of the example embodiments, and/or any portions thereof.

Even if the present inventive concepts include specific examples, it will be clear after comprehending the inventive concepts of the present application, various changes in form and details in these examples may be made without departing from the spirit and scope of the claims and their equivalents. The examples described herein should be considered descriptive only and not for restrictive purposes. The description of features or aspects in each example will be considered applicable to similar features or aspects in other examples. Appropriate results may be achieved if the described techniques are performed in different orders, and/or if the components in the described system, architecture, device or circuit are combined in different ways, and/or replaced or supplemented by other components or their equivalents. Therefore, the scope of the inventive concepts are not defined by the specific example embodiments described above, but by the claims and their equivalents, and all changes within the scope of the claims and their equivalents should be interpreted as included in the inventive concepts.

What is claimed is:

1. A hybrid auto focus tracking method, the hybrid auto focus tracking method comprising:
determining a first lens focusing position based on a phase difference of a phase detection image output by a phase detection image sensor;
determining a second lens focusing position based on a zoom ratio of feature points within a region of interest in a scene image output by the phase detection image sensor;
determining a final lens focusing position by fusing the first lens focusing position and the second lens focusing position; and
performing focus tracking of the phase detection image sensor based on the final lens focusing position.

2. The hybrid auto focus tracking method of claim 1, wherein the fusing the first lens focusing position and the second lens focusing position comprises:
determining a first confidence of the first lens focusing position, wherein the first confidence indicates a reliability that the first lens focusing position is able to be the final lens focusing position;
determining a second confidence of the second lens focusing position, wherein the second confidence indicates a reliability that the second lens focusing position is able to be the final lens focusing position; and
fusing the first lens focusing position and the second lens focusing position as the final lens focusing position based on the first confidence and the second confidence.

3. The hybrid auto focus tracking method of claim 2, wherein the first confidence is determined based on one or more of a weight factor of signal-to-noise ratio, a texture weight factor, and a correlation weight factor during phase difference calculation,
wherein the higher the signal-to-noise ratio of the phase detection image, the greater the weight factor of the signal-to-noise ratio, and the greater the first confidence,
wherein the more complex a texture of the phase detection image, the greater the texture weight factor, and the greater the first confidence,
wherein the smaller a correlation error of the phase detection image, the greater the correlation weight factor, and the greater the first confidence.

4. The hybrid auto focus tracking method of claim 2, wherein the smaller a fitting error when calculating the zoom ratio, the greater the second confidence.

5. The hybrid auto focus tracking method of claim 2, wherein the fusing the first lens focusing position and the second lens focusing position as the final lens focusing position comprises:
obtaining an addition result by adding a product of the first lens focusing position and the first confidence to a product of the second lens focusing position and the second confidence; and
calculating a resulting value obtained by dividing the addition result by a sum of the first confidence and the second confidence as the final lens focusing position.

6. The hybrid auto focus tracking method of claim 5, wherein the fusing the first lens focusing position and the second lens focusing position as the final lens focusing position further comprises:
in response to the sum of the first confidence and the second confidence being less than or equal to a threshold, setting the final lens focusing position of a previous frame as the final lens focusing position of a current frame,
wherein in response to the sum of the first confidence and the second confidence being greater than the threshold, performing the obtaining the addition result and the calculating the resulting value as the final lens focusing position.

7. The hybrid auto focus tracking method of claim 1, wherein the determining the first lens focusing position comprises:
obtaining an addition result by adding a product of a first lens calibration coefficient and a lens current position to a product of a second lens calibration coefficient and the phase difference; and
determining a result value obtained by dividing the addition result by a sum of the first lens calibration coefficient and the phase difference as the first lens focusing position, or
the determining the first lens focusing position comprises: using a table lookup method to determine the first lens focusing position based on the phase difference.

8. The hybrid auto focus tracking method of claim 1, wherein the determining the second lens focusing position comprises:
obtaining a first result by dividing the zoom ratio by a lens current position;
obtaining a second result by dividing a difference between 1 and the zoom ratio by a focal length of a lens; and
determining a reciprocal of a sum of the first result and the second result as the second lens focusing position,
wherein the zoom ratio is obtained based on position fitting of the feature points in the region of interest and a camera projection model.

9. The hybrid auto focus tracking method of claim 1, wherein the performing the focus tracking of the phase detection image sensor comprises:
obtaining the lens focusing position of a current frame by filtering and smoothing the final lens focusing position of the current frame and the final lens focusing positions of one or more previous frames; and
performing the focus tracking of the phase detection image sensor based on the lens focusing position.

10. A hybrid auto focus tracking device, the hybrid auto focus tracking device comprising:
a memory, storing executable instructions, and
a processor configured to execute the executable instructions to:
determine a first lens focusing position based on a phase difference of a phase detection image output by a phase detection image sensor;
determine a second lens focusing position based on a zoom ratio of feature points within a region of interest in a scene image output by the phase detection image sensor;
determine a final lens focusing position by fusing the first lens focusing position and the second lens focusing position; and
perform focus tracking of the phase detection image sensor based on the final lens focusing position.

11. The hybrid auto focus tracking device of claim 10, wherein the processor is configured to:
determine a first confidence of the first lens focusing position, wherein the first confidence indicates a reliability that the first lens focusing position is able to be the final lens focusing position;
determine a second confidence of the second lens focusing position, wherein the second confidence indicates a reliability that the second lens focusing position is able to be the final lens focusing position; and
fuse the first lens focusing position and the second lens focusing position as the final lens focusing position based on the first confidence and the second confidence.

12. The hybrid auto focus tracking device of claim 11, wherein the first confidence is determined based on one or more of a weight factor of signal-to-noise ratio, a texture weight factor, and a correlation weight factor during phase difference calculation,
wherein the higher the signal-to-noise ratio of the phase detection image, the greater the weight factor of the signal-to-noise ratio, and the greater the first confidence,
wherein the more complex a texture of the phase detection image, the greater the texture weight factor, and the greater the first confidence,
wherein the smaller a correlation error of the phase detection image, the greater the correlation weight factor, and the greater the first confidence.

13. The hybrid auto focus tracking device of claim 11, wherein the smaller a fitting error when calculating the zoom ratio, the greater the second confidence.

14. The hybrid auto focus tracking device of claim 11, wherein the processor is configured to:
obtain an addition result by adding a product of the first lens focusing position and the first confidence to a product of the second lens focusing position and the second confidence; and
calculate a resulting value obtained by dividing the addition result by a sum of the first confidence and the second confidence as the final lens focusing position.

15. The hybrid auto focus tracking device of claim 14, wherein the processor is further configured to:
in response to the sum of the first confidence and the second confidence being less than or equal to a threshold, setting the final lens focusing position of a previous frame as the final lens focusing position of a current frame,
wherein in response to the sum of the first confidence and the second confidence being greater than the threshold, performing the obtaining the addition result and the calculating the resulting value as the final lens focusing position.

16. The hybrid auto focus tracking device of claim 10, wherein the processor is configured to:
obtain an addition result by adding a product of a first lens calibration coefficient and a lens current position to a product of a second lens calibration coefficient and the phase difference; and
determine a result value obtained by dividing the addition result by a sum of the first lens calibration coefficient and the phase difference as the first lens focusing position, or
the processor is configured to: use a table lookup method to determine the first lens focusing position based on the phase difference.

17. The hybrid auto focus tracking device of claim 10, wherein the processor is configured to:
obtain a first result by dividing the zoom ratio by a lens current position;
obtain a second result by dividing a difference between 1 and the zoom ratio by a focal length of a lens; and
determine a reciprocal of a sum of the first result and the second result as the second lens focusing position,
wherein the zoom ratio is obtained based on position fitting of the feature points in the region of interest and a camera projection model.

18. The hybrid auto focus tracking device of claim 10, wherein the processor is configured to:
obtain the lens focusing position of a current frame by filtering and smoothing the final lens focusing position of the current frame and the final lens focusing positions of one or more previous frames; and
perform the focus tracking of the phase detection image sensor based on the lens focusing position.

19. A hybrid auto focus tracking method, the hybrid auto focus tracking method comprising:
determining a first lens focusing position based on a phase difference of a phase detection image output by a phase detection image sensor;
determining a second lens focusing position based on a zoom ratio of feature points within a region of interest in a scene image output by the phase detection image sensor;
determining a first confidence of the first lens focusing position, wherein the first confidence indicates a reliability that the first lens focusing position is able to be the final lens focusing position;
determining a second confidence of the second lens focusing position, wherein the second confidence indicates a reliability that the second lens focusing position is able to be the final lens focusing position;
determining a final lens focusing position by fusing the first lens focusing position and the second lens focusing position based on the first confidence and the second confidence; and
performing refocusing based on the difference between the final lens focusing position and a lens current focusing position.

20. The hybrid auto focus tracking method of claim 19, wherein the smaller a fitting error when calculating the zoom ratio, the greater the second confidence.
